(19) United States
(12) Patent Application Publication
(10) Pub. No.: US 2014/0325432 A1
(43) Pub. Date: Oct. 30, 2014

(54) SECOND SCREEN VIEW WITH MULTITASKING

(71) Applicant: MICROSOFT, Redmond, WA (US)

(72) Inventors: Steve Frederickson, Seattle, WA (US); Taylor Tang, Seattle, WA (US); Henry Tappen, Kirkland, WA (US); Krishna Venkatesh, Sammamish, WA (US); Jesse Satterfield, Seattle, WA (US); Christopher Swan, Bellevue, WA (US); Philip Lu, Kirkland, WA (US)

(73) Assignee: Microsoft, Redmond, WA (US)

(21) Appl. No.: 13/874,452

(22) Filed: Apr. 30, 2013

(51) Int. Cl. G06F 3/0481

(52) U.S. Cl. CPC G06F 3/0481
USPC 715/788

(57) ABSTRACT

Described herein are embodiments performed by a computing device capable of having a first display and a second display. The device may also execute a windowing system. Arbitrary applications execute on the computing device. Each such application has a corresponding application window managed by the windowing system. A start-projecting request may be received from an arbitrary one of the applications, and the windowing system may respond to the start request by generating, displaying, and managing a projection window. The application may generate and display content via the projection window. Responsive to the start-projecting request, display information about the first display and the second display may be used by the windowing system to display the projection window. A stop-projecting request from the application may cause the windowing system to terminate the projection window.

### BACKGROUND

For some time, in the field of computing, windowing environments have been able to provide applications with multiple windows. Applications having a clear distinction between control and content playback have sometimes used multiple windows to display content in one window and to display controls in another window. For example, media players, slide presentation applications, video games, and other applications have separated, with multiple windows, the display of content (display or presentation graphics) from the display of interactive graphic controls used to control the content. Such applications will be referred to loosely as presentation applications. To date, presentation-type applications have been developed to handle control-presentation separation on an ad hoc basis. That is, the applications themselves have been developed with logic to separate presentation of content from the controls that control the content. Some such applications require complex scenario-handling logic that often fails.

In addition it is has been known how to concurrently used multiple displays with one computing device. Typically, an operating system of a multi-display device handles the hardware details of managing multiple displays and may provide different display modes such as display mirroring or display concatenation. Again, presentation-style applications, if they have used multiple displays, have done so at the application level. Each application may have its own logic for how to deal with multiple monitors. Again, such logic can be complex and may fail under certain use-cases and display events. In addition, such applications or systems may not allow interaction with content or even other applications on a projected or secondary display.

Techniques related to system-managed multi-display projection logic are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Described herein are embodiments performed by a computing device capable of having a first display and a second display. The device may also execute a windowing system. Arbitrary applications execute on the computing device. Each such application has a corresponding application window managed by the windowing system. A start-projecting request may be received from an arbitrary one of the applications, and the windowing system may respond to the start request by generating, displaying, and managing a projection window. The application may generate and display content via the projection window. Responsive to the start-projecting request, display information about the first display and the second display may be used by the windowing system to display the projection window. A stop-projecting request from the application may cause the windowing system to terminate the projection window.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a computing device.

FIG. 2 shows example display outputs for a duplicate display mode and an extended display mode.

FIG. 3 shows an example implementation of windowing system.

FIG. 4 shows a general process related to use of a projection manager.

FIG. 5 shows a main application window and a presentation window.

FIG. 6 shows a process for starting a projection when the computing device is in a duplicate mode.

FIG. 7 shows a process for when a projection window is initiated and a target display already has application windows displayed thereby.

FIG. 8 shows a process for an application ending a projection.

FIG. 9 shows details of the computing device on which embodiments described above may be implemented.

### DETAILED DESCRIPTION

Embodiments discussed below relate to managing a secondary or projection view or window for arbitrary applications with advantage taken of multiple displays and with multitasking enabled on the multiple displays. While such functionality may be helpful for presentation applications, a system-managed projection window may have any arbitrary use and may display any content as determined by its corresponding parent application.

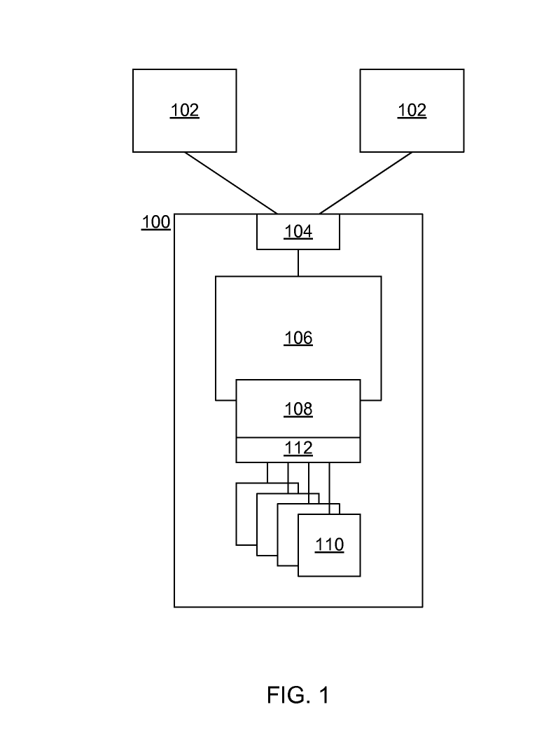

FIG. 1 shows a computing device 100. The computing device 100 may have one or more displays 102 connected therewith. The displays 102 may connect with the device 100 via an interface 104. The interface 104 may be a display adapter, a system bus, or, in the case of network-connected displays 102, some form of network interface card. An operating system 106 may manage the low-level hardware details of the displays 102 and provide an abstracted view of the displays 102 to a windowing system 108.

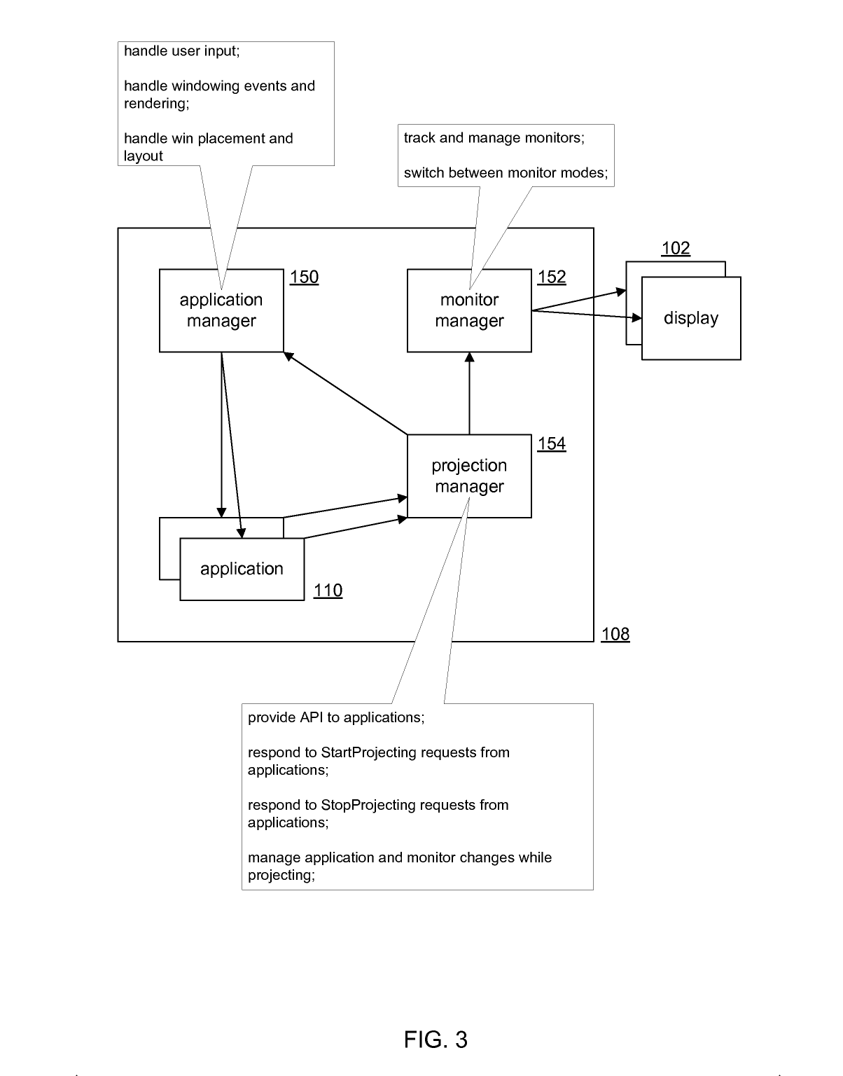

The windowing system may be partly integrated with or closely coupled with the operating system 106. For purposes herein, distinctions between these components are not significant. The windowing system 108 may have some functionality that is known in the computing arts, such as handling of input events (e.g., touches/strokes, clicks, keypresses, mouse drags, etc.) inputted by a user with various types of input devices. The windowing system 108 also manages application windows 110, handling related events or user interactions such as closing windows, moving windows, resizing windows, rendering multiple concurrent windows, possibly providing a background and controls not specific to an application, etc. Additional details of a windowing system are described later with reference to FIG. 3.

The windowing system 108 manages application windows 110. The application windows 110 correspond to respective processes executing on the computing device 100 and managed by the operating system 106. Note that each process need not have a window, and each window need not have its own unique process. Some processes may have multiple application windows 110. Again, windows and their basic features are well known in the art of computing and require no further explanation. In embodiments described herein, some applications (e.g., processes with application windows 110) may access services or functions of the windowing system 108 via one or more application programming interfaces (APIs) 112 or the like.

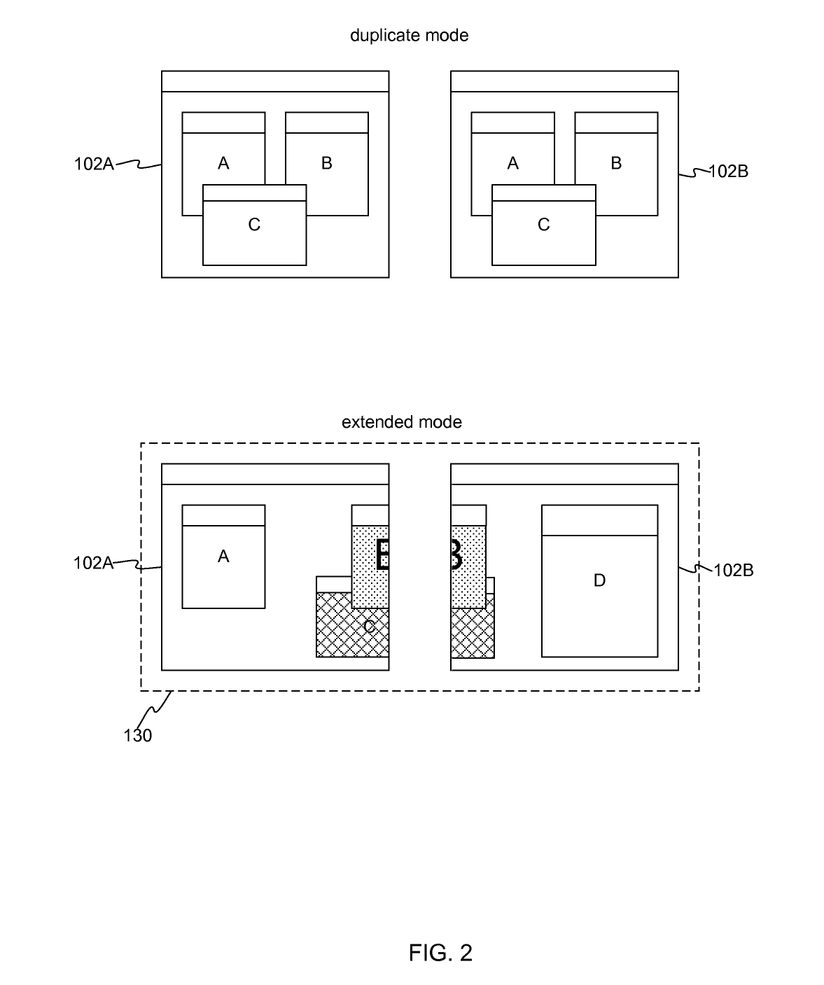

FIG. 2 shows example display outputs for a duplicate display mode and an extended display mode. In the top part of FIG. 2 a first display 102A and a second display 102B are connected to the same computing device 100. When the windowing system 108 is in duplicate mode the windowing system 108 provides what appears to be a single display to the applications (or other software) on the computing device 100. Whatever the windowing system 108 renders as output is displayed in duplicate on both displays 102A, 102B.

In extended mode the displays 102A, 102B are treated as one logic display surface extended across two displays. Various forms of extend mode may be implemented. In one form the displays 102A, 102B are abstracted to a virtual display 130 which is indistinguishable from a single display. All graphics is bridged across the displays and the individual displays may not have distinct visibility to applications. Another form of extend mode treats the displays partly as a single device and partly as multiple devices. For example, a user shell or graphical user interface (GUI) might have distinct environmental components such as taskbars or application icons duplicated on each display, but at the same time this form of extend mode might provide applications with the ability to individually address the displays 102A, 102B. For purposes herein, “extend mode” refers to nearly any system-provided multi-display mode that allows different application windows to be displayed on different respective displays.

FIG. 3 shows an example implementation of windowing system 108. The windowing system 108 has an application manager 150, a monitor manager 152, and a projection manager 154. While a component-wise division of responsibilities is convenient for software development and for explanation, any arbitrary design may be used; the particular components and their relations is not significant. With that said, the application manager 150 is a component that handles high level application management functions such as starting and stopping applications, installing applications, displaying indicia of executing applications, providing user tools for interacting with and managing applications, and so forth.

An application may be a first order object having a primary window that can be interactively moved, resized, moved from one display to another, etc. In one embodiment, the application manager may have layout logic that manages the layout of application windows 110. For instance, the application manager (or a layout manager) may allow a user to interactively insert an application window 110, interactively replace one application window 110 with another, concurrently reallocate display space among application windows 110 (e.g., using moveable dividers), interactively mode a window, and so forth. In sum, the application manager 150 provides the user with multiple application windows for multi-tasking.

The monitor manager 152 may handle hardware details of having multiple displays 102. The monitor manager 152 may operate as a service providing abstract access to display functionality. For example, the monitor manager 152 may handle the addition and removal (e.g., turning on/off, connecting/disconnecting, enabling/disabling) of displays. The monitor manager 152 also provides the different display modes such as extend mode and duplicate mode. The monitor manager 152 may also provide to applications, the application manager 150, and the projection manager 154 information about the current display mode, information about which displays are available and their properties, and others. In addition, the monitor manager 152 may switch between display modes as instructed by the projection manager 154.

The projection manager 154 is a component that allows applications to use window projection functionality without concern for implementation details. The projection manager 154 may be accessible through an API that includes at least a start-projecting call and a stop-projecting call. When an application needs a projection window for presentation-style display of content, the application may use the projection manager to start projecting.

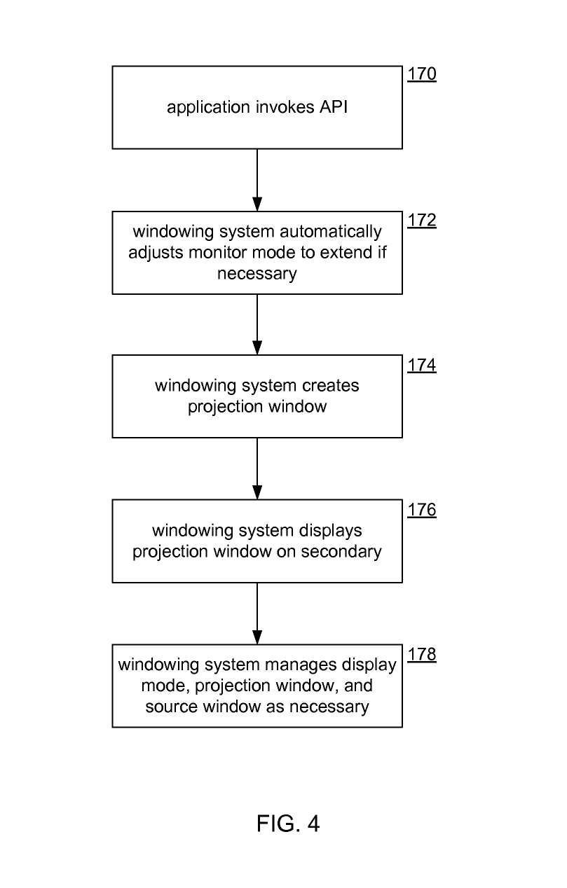

FIG. 4 shows a general process related to use of the projection manager 154. Initially, at step 170, an application invokes an API to request the projection manager 154 to provide a managed or curated projection window. At step 172 the projection manager, as part of the windowing system, uses the monitor manager 152 to switch to switch to the extend display mode, if necessary. At step 174 the projection manager requests the windowing system (perhaps the application manager) for a new window which is formed as a child window of the application requesting the projection window. The projection window is a fully fledged window object managed by the windowing system and the application manager. Nonetheless, lifetime and behavior of the projection window is managed or curated by the projection manager 154.

The projection manager 154 may go through a decision making process to determine on which of the two (or more) displays the projection window is to be displayed. When switching from a duplicate mode to the extend mode the main or primary window of the requesting (projecting) application may not be associated with either display. Consequently the projection manager 154 may decide for the user which display will display the primary application window and which display will display the projection window. For instance, the projection manager 154 may take into account the display types (e.g., projector), the size of the displays, whether a display has input associated with it (e.g., a touch-sensitive display), previous display uses, etc. As will be discussed later, the projection manager 154 will also generate and manage the projection window even when there is only one display available or when the display mode is locked into duplicate mode per a user preference.

After the projection window has been displayed, at step 178 the windowing system and its components begin managing the projection window much like any other application window, for example by responding to user input directed to or affecting the main application window, the projection window, or other application windows that might be displayed on one or more of the displays after projecting has begun. During this time, the content displayed in the projection window may be controlled by user interaction with the main window or user interface elements thereof such as “play”, “skip”, “rewind”, “stop”, or any other control not necessarily of the playback control variety (for example, game controls may be used to play a game with the projection window displaying game graphics).

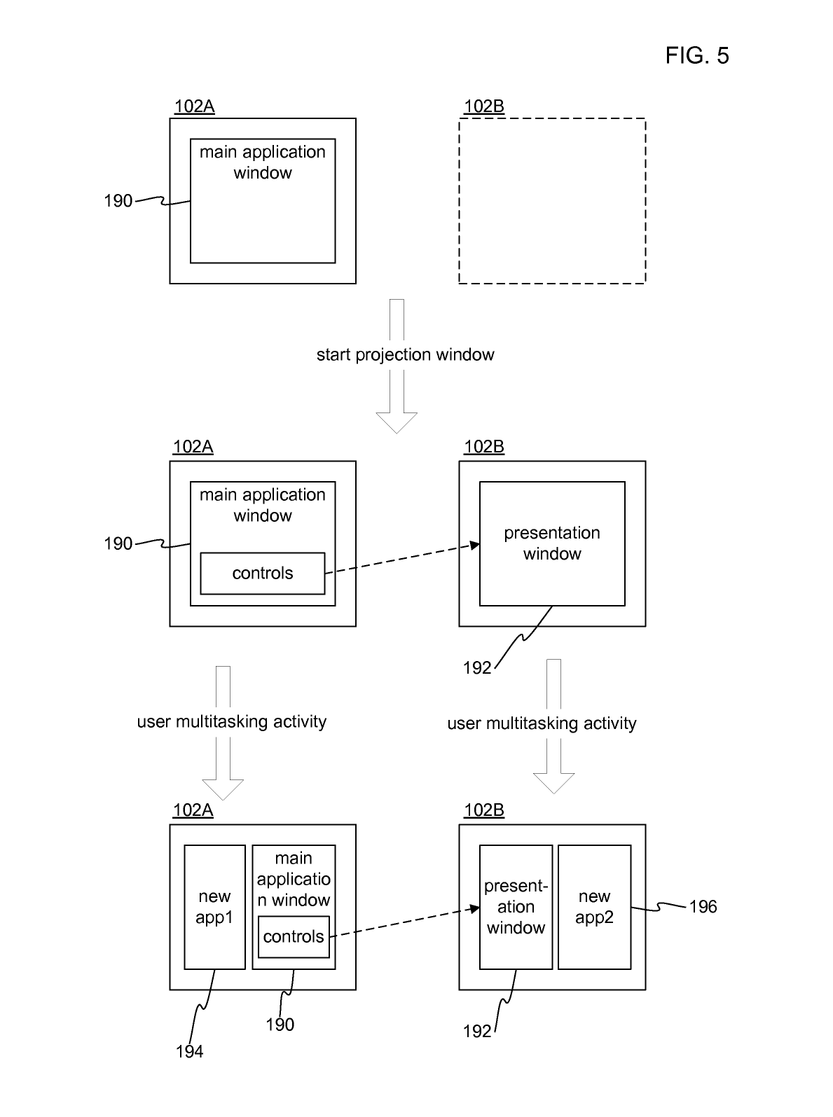

FIG. 5 shows a main application window 190 and a presentation window 192. The top of FIG. 5 corresponds to a time prior to initiation of the presentation window 192; the presence or status of second display 102B is indeterminate. The middle part of FIG. 5 corresponds to a time after the projection window 192 has been displayed. The application window may have internal programming such that when the application is instructed to enter a presentation mode the controls are displayed and the presentation window 192, perhaps controlled in part by the controls, is generated and displayed on the second display 102B.

At the same time, the main application window 190 and the presentation window 192 (a child window of the application) are objects subject to user manipulation and management by the application manager 150. In other words, at any time the user might change which displays are available, may add or remove windows to/from either display 102A, 102B, and so forth. In other words, both displays 102A, 102B may be thought of as providing a multi-tasking user interface in conjunction with a system-curated or managed presentation view. The lower parts of FIG. 5 reflects example possible appearance of either display 102A, 102B after multitasking activity. In either or both cases a first new application 194 or a second new application 196 can be added by a user. In one embodiment, if input cannot be associated with display 102B then multitasking thereon may be limited or prevented.

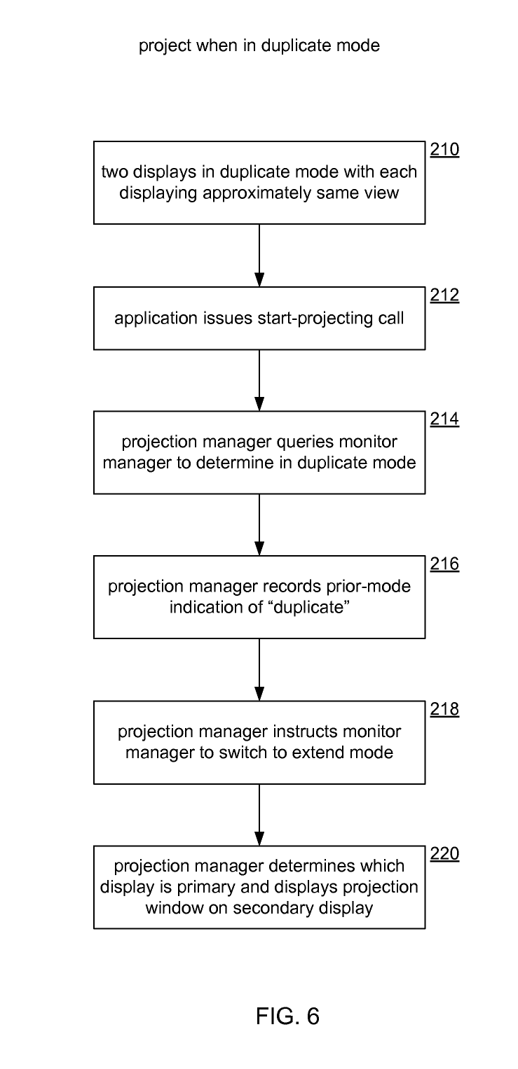

FIG. 6 shows a process for starting a projection when the computing device is in a duplicate mode. At step 210, initially the computing device is in duplicate mode. At step 212 the application issues a start-projecting call. At step 214 the projection manager queries the monitor manager to determine that the display mode is in duplicate mode. At step 216 the projection manager records a prior-mode indication which indicates that the display mode was “duplicate” before the projection started. At step 218 the projection manager tells the monitor manager to switch to extend mode and at step 220 the projection manager determines which display is primary and which is secondary and displays the main application window and the projection window accordingly.

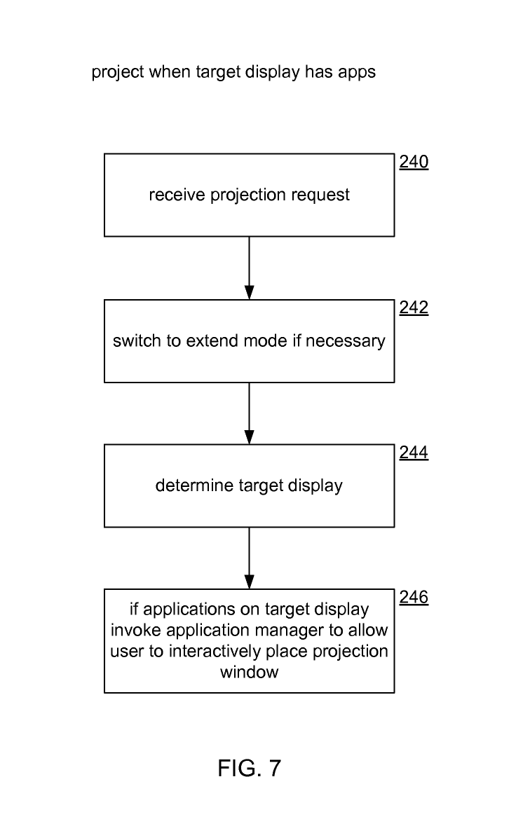

FIG. 7 shows a process for when a projection window is initiated and a target display already has application windows displayed thereby. At step 240 a projection request is made. At step 242 a switch to extend mode and notation of same is made, if necessary or possible. At step 242 a target display for the projection window is determined. Regarding display selection, an algorithm or heuristic can determine display preference. For example, the algorithm may look to which display has user input. Application arrangement can be another clue indicating a user's display preference. At step 244 if there are applications already on the target display then the application manager allows the user to interactively place the projection window (or automatically places the projection window). The result after step 246 might look like display 102B in the lower right part of FIG. 5 (but with “app2” a pre-existing application rather than a later-added application).

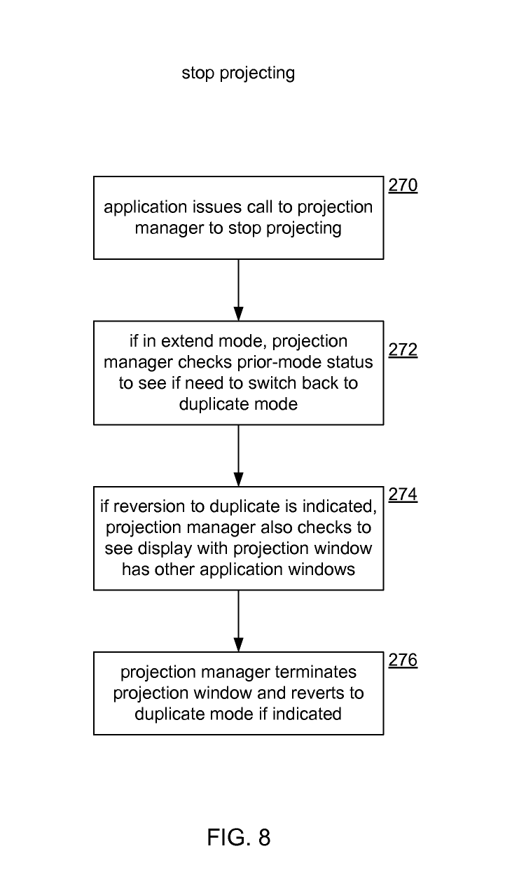

FIG. 8 shows a process for an application ending a projection. At step 270 the relevant application issues a call to the API of the projection manager to stop projecting. If in extend mode the projection manager may check its prior-mode indication (pre-projection duplicate/extend mode per step 216) and if the prior-mode was “duplicate” then the projection may instruct the monitor manager to revert to duplicate mode. However, if there is indication that the user has performed multitasking (or other activity) on either display then the projection manager may opt to leave the display mode in extend mode. For instance, at step 274 the projection manager may check to see if other application windows have been added to either display (as, for example, shown in the lower third of FIG. 5).

While two-display embodiments have been described above, the same embodiments are readily extendible to any number of displays. In one embodiment the presentation activation request may be denied by the presentation manager if the requesting application is not the active application. It is also possible that the application may itself make sure it is active before issuing a projection call, or there may be a separate API. The window manager is also a point where limiting projection to an active application can be implemented if needed. Note that the active application is of interest at least in part because of the multitasking environment.

The presentation manager may have other calls related to presentation. For example, a call may be provided to allow an application to swap its presentation window and main window between displays. An application may also query about the presence of a second display or can receive a notification when a second display becomes available. It may be practical in some implementations to allow an application to have only one presentation window. In yet another embodiment closing the main application window also closes its presentation window (or all non-projection windows of the application, as the case may be).

In some implementations or cases a projected window may be able to accept input but does not afford input. That is, the windowing system might assume that there is no input on a remote/second screen (for example, a remote window goes away when the local window is closed). If a user does have input on the remote/second screen (for example, a touch panel), the user can touch it and interact with it just like any other screen.

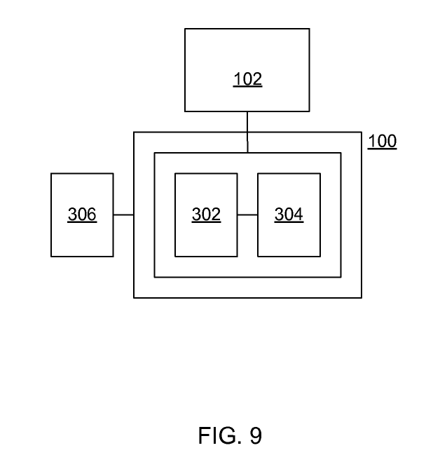

FIG. 9 shows details of the computing device 100 on which embodiments described above may be implemented. The computing device 300 may have the display 102 for displaying, as well as storage 302 and a processor 304. These elements may cooperate in ways understood in the art of computing. In addition, input devices 306 may be integrated with or in communication with the computing device 300. The display 102 may be a touch-sensitive display that also functions as an input device. The computing device 300 may have any form factor or be used in any type of encompassing device. For example, touch-sensitive control panels are often used to control appliances, robots, and other machines. The computing device 100 may be in the form of a handheld device such as a smartphone, a tablet computer, a gaming device, a server, or others.

Embodiments and features discussed above can be realized in the form of information stored in volatile or non-volatile computer or device readable devices. This is deemed to include at least devices such as optical storage (e.g., compact-disk read-only memory (CD-ROM)), magnetic media, flash read-only memory (ROM), or devices for storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile devices storing information that allows a program or executable to be loaded and executed. The embodiments and features can be performed on any type of computing device, including portable devices, workstations, servers, mobile wireless devices, and so on.

1. A method performed by a computing device comprising a first display, a second display, an input device, a processor and storage executing a windowing system, the method comprising:
executing arbitrary applications on the computing device, each application having a corresponding application window managed by the windowing system;
receiving a start request from an arbitrary of the applications to start projecting, and responding to the start request by the windowing system generating, displaying, and managing a projection window, the application generating and displaying content via the projection window;
responsive to the start request determining display information about the first display and the second display, and using the display information by the windowing system display the projection window; and
receiving a stop request from the application to stop projecting, and responding to the stop request by the windowing system terminating the projection window.

2. A method according to claim 1, wherein the display information indicates whether a display is available for projecting.

3. A method according to claim 2, the method further comprises responding, by the windowing system, to the display information by switching from a duplicate mode to an extend mode and displaying the projection window on whichever of the displays is not displaying the application window.

4. A method according to claim 3 further comprising storing switch information indicating that the windowing system has switched from the duplicate mode to the extend mode.

5. A method according to claim 4, the responding to the stop request further comprising automatically determining whether to switch from the extend mode to the duplicate mode based on the switch information and whether there is user activity while presenting the projection window.

6. A method according to claim 4, wherein the responding to the stop request further comprises determining whether other application windows are displayed on the display not displaying the application window, and when so determined remaining in extend mode when the projection window is terminated.

7. A method according to claim 2, wherein the application window and the projection window both comprise application windows managed by the windowing system such that the windowing system enables the application window and the projection window to be interactively manipulated by a user of the computing device, the interactive manipulation including causing the application window to share its display with a window of another arbitrary application and causing the projection window to share its display with a window of another arbitrary application.

8. One or more computer readable storage devices storing information to enable a computing device to perform a process, the process comprising:
providing an application programming interface (API) available for arbitrary applications executing on the computing device, the API including a start-projecting call and a stop-projecting call; and
responding to invocations of the start-projecting call by the applications by creating and displaying respective projection windows, wherein the displaying is performed by executing display-managing logic that manages multiple displays when connected with the computing device, and wherein the projection windows are child windows of respective application windows such the projection windows can interacted with and arranged on any displays connected with the computing device.

9. One or more computer readable storage devices according to claim 8, the process further comprising responding to projections of the stop-projecting call by terminating the projection windows.

10. One or more computer readable storage devices according to claim 9, wherein the terminating comprises executing display managing logic that determines whether to revert from an extended multi-display mode to a duplicate multi-display mode.

11. One or more computer readable storage devices according to claim 9, wherein when the display-managing logic indicates that only one display is available a corresponding projection window is displayed on the one display and when the display-managing logic indicates that two displays are available another corresponding projection window is displayed on a display not displaying an application window that created the other projection window via a start-projecting call.

12. One or more computer readable storage devices according to claim 8, wherein application windows and the projection windows are all managed by an application manager that allows a user to open, close, and arrange windows on any displays connected with the computing device.

13. One or more computer readable storage devices according to claim 12, wherein a user is able to arrange for concurrent display of both a first projection window and a first application window on either a same display or on separate displays.

14. One or more computer readable storage devices according to claim 13, wherein a windowing system implementing the API allows the first application window and the first projection window to be displayed either on a same display connected with the computing device or on respective different displays connected with the computing device and the windowing system allows the user to interact with the first application window and the first projection window as arbitrary windows managed by the windowing system.

15. One or more computer readable storage devices according to claim 14, the process further comprising responding, by the windowing system, to a start-projecting call by automatically switching from a duplicate-display mode to an extended-display mode, the extended-display mode managing two or more displays as a single virtual display.

16. A computing device comprising one or more displays, an input device, a processor, and storage, the storage storing:
an application manager that when executed by the processor manages user execution of arbitrary applications executed by the processor;
a display manager that manages displays for the computing device; and
a projection manager that when executed manages projection windows for the applications, wherein the projection manager uses the display manager and the application manager to generate and display the projection windows.

17. A computing device according to claim 16, the computing device comprising a first display and a second display, wherein the display manager is able to alternate between an extended mode and a duplicate mode, the extended mode allowing windows to be displayed individually on the first display and the second display, the duplicate mode duplicating graphic content displayed on the first display and the second display.

18. A computing device according to claim 16, wherein the projection manager comprises an API that the applications can invoke to swap displays.

19. A computing device according to claim 16, wherein the projection manager manages the projection windows responsive to receiving display events and application events.

20. A computing device according to claim 16, wherein a projection window does not afford user input but can accept user input.
